(19) United States
(12) Patent Application Publication
(10) Pub. No.: US 2002/0179793 A1
(43) Pub. Date: Dec. 5, 2002

(54) Device with retractable hook for hanging a stocking

(76) Inventor: Hsien Hsing Wang, Central Commercial Hin Lei (MO)

Correspondence Address: Morgan & Finnegan L.L.P., Maria C.H. Lin, 345 Park Avenue, New York, NY, 10154-0053, US

(21) Appl. No.: 09/870,888

(22) Filed: May 31, 2001

(51) Int. Cl. F16B 45/00

(52) U.S. Cl. 248/308

(57) ABSTRACT

The present invention is directed to a device with a retractable hook for hanging an ornament. The device with a base is provided with a narrow trench to accommodate a retractable hook, comprising a bar with a hook at the end of a bar, with one end of the trench extending to the edge of the base and the opposite end of the trench provided with an indentation to accommodate the hook end of the retractable hook, and with the opposite end swingingly attached to the central portion of the trench. The trench may be provided with a first affixing means on one side of the central portion where the retractable hook is attached to the trench to affix the bar of the retractable hook to the bottom of the trench. The trench may also be provided with a second affixing means on the other side of the central portion of the trench.

### BACKGROUND OF INVENTION

This invention relates to a device provided with a retractable hook for hanging a holiday ornament. More particularly, the retractable hook is provided for hanging a Christmas or holiday stocking where desired, for example, on a fireplace mantel.

Historically, Christmas or holiday stockings or hanging ornaments are displayed by attaching a nail or other attaching means on a fireplace mantel, a wall or any other location where the stocking or ornament is desired to be displayed. Unfortunately, that method causes an unsightly hole to be permanently put into the fireplace mantel, the wall or any other location. In recent years, nails have been replace with scotch tape or velcro attaching means for the display of ornaments. However, scotch tape or velcro attaching means are not sufficiently strong for display of heavier ornaments such as Christmas or holiday stockings, especially when gifts are placed in the stockings.

Other means for display of such ornaments have been developed. A commercially available means is a holiday ornament, such as a brass angel or a pot is provided with a hook extending beyond its base for hanging a Christmas or holiday stocking. See, for example, U.S. Design Pat. No. 381,597, which discloses a device for hanging a holiday stocking wherein the device is a rectangular decorated plaque with a hook for hanging a holiday stocking. Such an ornament provides a convenient way of hanging a Christmas or holiday stocking. However, the ornament itself cannot be displayed alone because the hook would be visible. Moreover, it is difficult to store such ornaments because the hook protrudes from the ornament and may break off.

### SUMMARY OF INVENTION

The present invention is directed to a device with a retractable hook for hanging an ornament. The device with a base is provided with a narrow trench to accommodate a retractable hook, comprising a bar with a hook at the end of a bar, with one end of the trench extending to the edge of the base and the opposite end of the trench provided with an indentation to accommodate the hook end of the retractable hook, and with the opposite end of the retractable hook swingingly attached to the central portion of the trench. The trench may be provided with a first affixing means on one side of the central portion where the retractable hook is attached to the trench to affix the bar of the retractable hook to the bottom of the trench. The trench may also be provided with a second affixing means on the other side of the central portion of the trench.

When the hook is affixed to the first affixing means on the side closer to the indentation, the hook is retracted and hidden from view. When the hook is affixed to the second affixing means on the side closer to the edge of the base of the ornament, the hook end is exposed and may be used to hang a Christmas or holiday stocking or a second ornament. In this manner, the hook may be hidden from view when it is not to be used to hang a Christmas or holiday stocking or a second ornament. If the device is an ornament itself, it may be displayed as such with the hook retracted. Moreover, the hook when retracted will make it easier to store the device. Further the device may be provided with more than one retractable hook for hanging a plurality of Christmas or holiday stockings.

The following drawings are provided to illustrate the invention and is not meant to be used to limit the scope thereof.

### BRIEF DESCRIPTION OF DRAWINGS

FIG. 1 illustrates the base of a device provided with a retractable hook wherein the hook is retracted.

FIG. 2 illustrates the base of the device with the hook exposed.

FIG. 3 shows the attachment of the retractable hook to the center portion of the trench, the affixing means in the form of magnets affixed to the bottom part of the trench.

FIG. 4 shows the use of velcro tabs as the affixing means for the attachment of the retractable hooks.

### DETAILED DESCRIPTION

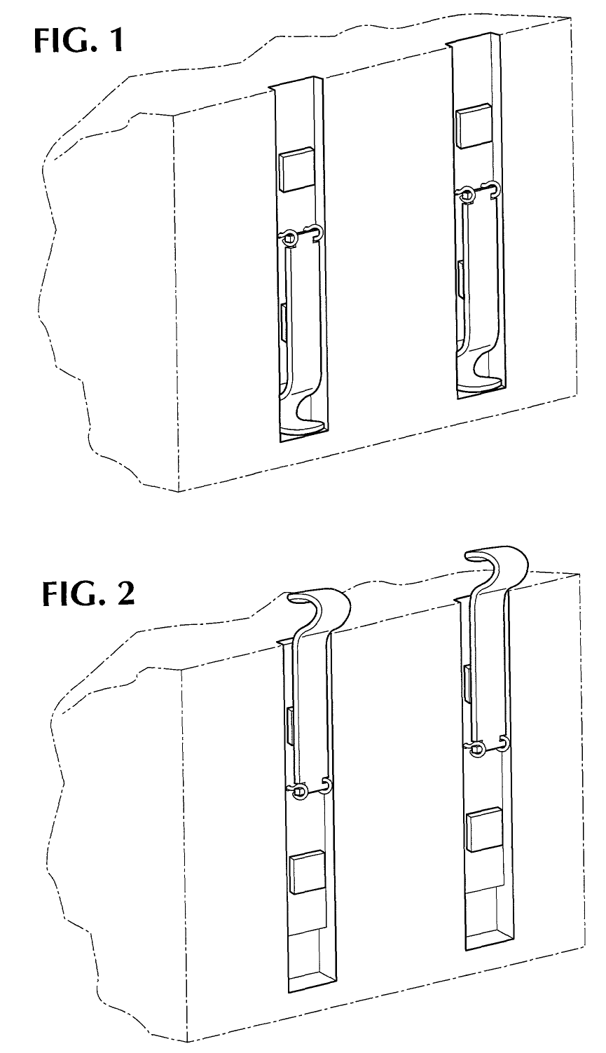

The present invention is directed to a device with a retractable hook for hanging an ornament. The device with a base is provided with a narrow trench having side walls and a bottom in the base to accommodate a retractable hook comprising a bar with a hook at one end of the bar, with one end of the trench extending to the edge of the base and the opposite end of the trench provided with an indentation to accommodate the hook end of the retractable hook swingingly attached by attaching means at the end opposite to the hook end of the retractable hook to the central portion of the trench. The trench may be provided with a first affixing means on one side of the central portion where the retractable hook is attached to the trench to affix the retractable hook to the bottom of the trench. The trench may also be provided with a second affixing means on the other side of the central portion where the retractable hook is attached to affix the retractable hook to the other side to the bottom of the trench. See FIG. 1 and FIG. 2.

The device may be in the form of an ornament with a base of a sufficient size to accommodate the trench for the retractable hook, a bar with a hook at one end. The thickness of the trench should be sufficient to accommodate the thickness of the bar of the retractable hook. The retractable hook is attached to the central portion of the trench by attaching means. The attaching means may be a nail or a screw with a head that can be used to attach the retractable hook to the trench. In the drawings, FIGS. 1-4, two attaching means are shown for each retractable hook. Each of the attaching means is shown as a screw with a head in the form of a shepherd's hook. A protruding means provided at the end at each side of the bar of the retractable hook may be inserted into the eye of the shepherd' hook of the screw or nail to attach the retractable hook to the trench such that the retractable hook can be swung from one side of the trench to the other side. Alternatively, a protruding means may be provided on the head of the nail or screw for insertion into an eye provided on the retractable hook, or the retractable hook may be attached to the trench by other similar known attaching means for swingingly attaching two items.

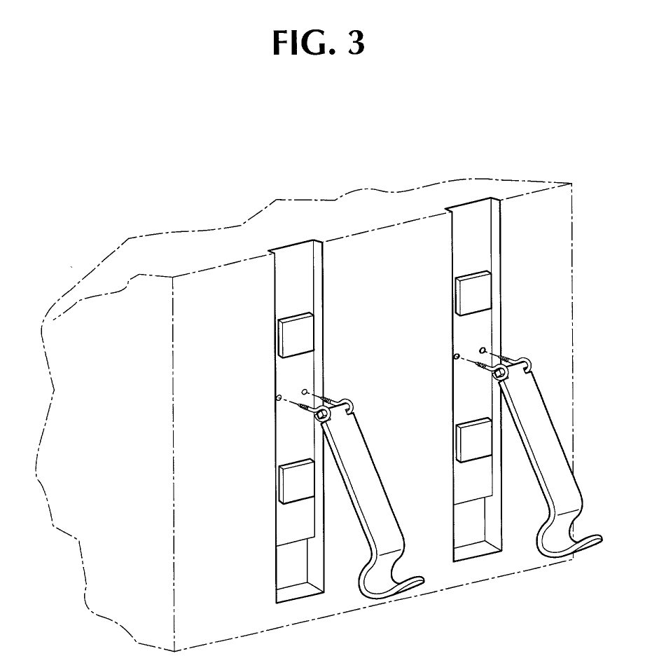

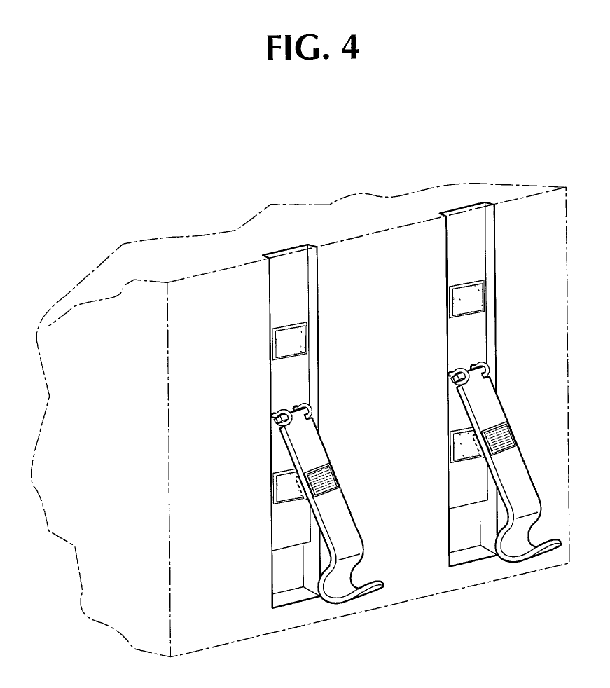

Affixing means are provided in the trench for affixing the retractable hook to one side of the trench or the other side of the trench. The affixing means may be in the form of small magnet tabs if the retractable hook is made of a ferrous magnetic metal. See FIG. 3. The affixing means may be in the form of velcro tabs adhesively attached to the bottom of the trench. See FIG. 4. In such a case, the retractable hook may be made of plastic or any material to which velcro tabs are adhesively affixed to mate with the velcro tabs placed at the bottom of the trench.

1. A device with a retractable hook for hanging an ornament comprising a base wherein a narrow trench, having side walls and a bottom to accommodate the retractable hook comprising a bar with a hook at one end of the bar, is provided in the base with one end of the trench extending to the edge of the base and the opposite end of the trench provided with an indentation to accommodate the hook end of the retractable hook swingingly attached to the central portion of the trench by attaching means at the bar end of the retractable hook.

2. A device according to claim 1 wherein the device is an ornament.

3. A device according to claim 1 wherein the attaching means is selected from a group consisting of a nail with a head in the form of a shepherd's hook and a screw with a head in the form of a shepherd's hook and the bar end of the retractable hook is provided with protruding means to be inserted into the eye of the shepherd's hook.

4. A device according to claim 2 wherein the attaching means is selected from a group consisting of a nail with a head in the form of a shepherd's hook and a screw with a head in the form of a shepherd's hook and the bar end of the retractable hook is provided with protruding means to be inserted into the eye of the shepherd's hook.

5. A device according to claim 1 wherein a first affixing means is provided on one side at the bottom of the trench for affixing the retractable hook to one side of the trench.

6. A device according to claim 2 wherein a first affixing means is provided on one side at the bottom of the trench for affixing the retractable hook to one side of the trench.

7. A device according to claim 3 wherein a first affixing means is provided on one side at the bottom of the trench for affixing the retractable hook to one side of the trench.

8. A device according to claim 4 wherein a first affixing means is provided on one side at the bottom of the trench for affixing the retractable hook to one side of the trench.

9. A device according to claim 5 wherein the first affixing means is a magnet and the retractable hook is made of a ferrous magnetic metal.

10. A device according to claim 6 wherein the first affixing means is a magnet and the retractable hook is made of a ferrous magnetic metal.

11. A device according to claim 7 wherein the first affixing means is a magnet and the retractable hook is made of a ferrous magnetic metal.

12. A device according to claim 8 wherein the first affixing means is a magnet and the retractable hook is made of a ferrous magnetic metal.

13. A device according to claim 5 wherein a second affixing means is provided on the other side at the bottom of the trench for affixing the retractable hook to the other side of the trench.

14. A device according to claim 6 wherein a second affixing means is provided on the other side at the bottom of the trench for affixing the retractable hook to the other side of the trench.

15. A device according to claim 7 wherein a second affixing means is provided on the other side at the bottom of the trench for affixing the retractable hook to the other side of the trench.

16. A device according to claim 8 wherein a second affixing means is provided on the other side at the bottom of the trench for affixing the retractable hook to the other side of the trench.

17. A device according to claim 13 wherein a second affixing means is a magnet and the retractable hook is made of a ferrous magnetic metal.

18. A device according to claim 14 wherein the first affixing means is a magnet and the retractable hook is made of a ferrous magnetic metal.

19. A device according to claim 15 wherein the first affixing means is a magnet and the retractable hook is made of a ferrous magnetic metal.

20. A device according to claim 16 wherein the first affixing means is a magnet and the retractable hook is made of a ferrous magnetic metal.
